(19) United States
(12) Patent Application Publication
(10) Pub. No.: US 2013/0297718 A1
(43) Pub. Date: Nov. 7, 2013

(54) SERVER DEVICE, CLIENT DEVICE, DATA SHARING SYSTEM AND METHOD FOR SHARING DATA BETWEEN CLIENT DEVICE AND SERVER DEVICE THEREOF

(71) Applicant: SAMSUNG ELECTRONICS CO., LTD., Suwon-si (KR)

(72) Inventors: Yaduvir SINGH, Noida (IN); Bhuvnesh AGRAWAL, Noido (IN)

(73) Assignee: SAMSUNG ELECTRONICS CO., LTD., Suwon-si (KR)

(21) Appl. No.: 13/888,830

(22) Filed: May 7, 2013

(30) Foreign Application Priority Data
May 7, 2012 (IN) 1753/CHE/2012
Apr. 5, 2013 (KR) 10-2013-0037702

(51) Int. Cl. G06F 3/06

(52) U.S. Cl. CPC G06F 3/0673
USPC 709/213

(57) ABSTRACT

A server device, data sharing system, and data sharing method thereof are provided. A data sharing method of the server device for sharing data with the client device receives a request used for communication with the client device from a client device, determines reliability of the client device, and when determined that there is reliability in the client device, emulates a virtual USB device which includes a large capacity device, transmits a USB control message used to access the large capacity device of the virtual USB device to the client device, and when the client device is authenticated through the USB control message, shares data with the client device.

### CROSS-REFERENCE TO RELATED APPLICATIONS

This application claims priority from Indian Patent Application No. 1753/CHE/2012, filed in the Indian Patent Office on May 7, 2012, and Korean Patent Application No. 10-2013-0037702, filed on Apr. 5, 2013, the disclosure of which is incorporated herein by reference.

### BACKGROUND

1. Field

Methods and apparatuses consistent with exemplary embodiments relate to a multimedia environment, and more particularly to an environment of sharing multimedia contents from one multimedia apparatus to another multimedia apparatus.

2. Description of the Prior Art

Server/client systems are widely used for various purposes, for example, business, database access, mail services and the like. A server/client system includes a server and multiple clients. The server services several requests of the clients. The clients are remotely connected to the server over a computer network. However, secure sharing of data, present in the server, with the clients is a major issue.

Conventional technique provides a client/server architecture system that enables safe sharing of a device. The method includes connecting the device, to the server, that can be accessed from a client. The device connected to the server can be accessed from the client by merely connecting the device to the server. However, the technique requires the device to be physically connected to the server. Further, one or more USB ports are required for connecting the device. Hence, the device cannot be connected to electronic devices that do not include a USB port.

Another conventional technique aims at sharing the server with multiple clients by extending a standard peripheral bus driver of the server over an Internet Protocol (IP) network. A virtual peripheral bus driver is used to provide a virtual extension of the standard peripheral bus driver that enables the clients to access the server. However, existing art requires an external USB device to be physically connected to the server. Further the existing art does not provide a security feature to the client and hence any client is allowed to connect and further access the server device.

Further, with the continuing development of cloud computing, different devices need to be connected over a network to share their computational resources. Further, a user may wish to perform various tasks, for example, but not limited to, store and access personal content, play media content or perform word processing on a remote device since an electronic device of the user may not include hardware and software requirements for performing the tasks. In one example, an electronic device may not include an USB port. Hence the media content present in an USB device cannot be played by the electronic device.

In light of the foregoing discussion there is a need for an efficient system and a method for connecting a client to a server without the need for physically connecting external devices.

### SUMMARY

The purpose of the present disclosure is to provide a server device which enables data sharing between a server device and client device without physical connection of a USB device, client device, data sharing system, and data sharing method thereof

According to an exemplary embodiment of the present disclosure, a data sharing method of a first device for sharing data with a second device may include receiving a request related to communicating with the second device, from the second device; determining a reliability of the second device; emulating a virtual universal serial bus (USB) device including a storage device, when it is determined that there is reliability in the second device; transmitting a USB control message used in accessing the storage device of the virtual USB device, to the second device; and sharing data with the second device, when the second device authenticates via the USB control message.

The determining may comprise storing a list including information on second devices for which data sharing is approved; determining whether or not the second device is included in the list; and determining that there is reliability in the second device, when the second device is included in the list.

The method further comprises encrypting the USB control message, and the encrypted USB control message may be decrypted by the second device.

The USB control message may be transmitted in a format of a plurality of URB (Universal serial bus request block) units.

The USB control message may be processed by a plurality of drivers mounted on the second device, and the second device may use the processed USB control message to determine whether or not the second device has authority to access the storage device of the virtual USB device.

According to an exemplary embodiment of the present disclosure, a server device for sharing data with a client device may comprise a communication interface configured to perform communication with the client device; and a controller configured to control the communication interface to receive a request related to communicating with the client device, from the client device, determine reliability of the client device, and when it is determined that there is reliability in the client device, emulate a virtual universal serial bus (USB) device including a storage device, control the communication interface to transmit a USB control message used in accessing the device of the virtual USB device, to the client device, and share data with the client device, when the client device authenticates via the USB control message.

The server device may include a storage unit and the storage unit may store a list including information on client devices for which data sharing is approved, and the controller may determine whether or not the client device is included in the list, and when the client device is included in the list, determines that there is reliability in the client device,.

The controller may encrypt the USB control message, and the encrypted USB control message is decrypted by the client device.

The controller may control the communication interface to transmit USB control messages in a format of a plurality of URB (Universal serial bus request block) units.

The USB control message may be processed by a plurality of drivers mounted on the client device, and the client device may use the processed USB control message to determine whether or not the client device has authority to access the storage device of the virtual USB device.

According to an exemplary embodiment of the present disclosure, a data sharing method of a data sharing system including a first device and a second device may comprise transmitting by the second device a request used to connect the second device and the first device, to the first device; determining, by the first device, reliability of the second device, so that the second device can access the first device; emulating by the first device a virtual universal serial bus (USB) device including a storage device, when it is determined that there is reliability in the second device; transmitting by the first device a USB control message used for accessing the storage device of the virtual USB device, to the second device; processing by the client device the transmitted USB control messages; and obtaining by the client device authority to access the large capacity of the virtual USB device using the processed USB control message.

According to an exemplary embodiment of the present disclosure, a data sharing method of a second device may comprise transmitting a request used to connect the second device and a first device to the first device; receiving a universal serial bus (USB) control message used for accessing a storage device of a virtual USB device from the first device; processing transmitted USB control messages; and accessing the storage device of the virtual USB device using at least one from among the processed USB control messages.

The virtual USB device may be emulated by the first device when it is determined that there is reliability in the second device.

The USB control message received from the first device maybe encrypted, and decrypting the encrypted USB control message may be further included.

The USB control message may comprise at least one software condition enabling the second device to access the storage device of the virtual USB device.

According to an exemplary embodiment of the present disclosure, a client device for sharing data with a first device may comprise a communication interface configured to communicate with the first device; and a controller configured to transmit a request used to connect the client device and server device to the server device, controls the communication interface to receive a universal serial bus (USB) control message used to access a storage device of a virtual USB device from the first device, and process the transmitted USB control messages to access the storage device of the virtual USB device.

The virtual USB device may be emulated by the first device, when it is determined that there is reliability in the second device.

The USB control message received from the first device may be encrypted, and the controller may decrypt the encrypted USB control message.

The USB control message may include at least one software condition which enables the second device to access the storage device of the virtual USB device.

The first device as described above may be a server device, and the second device may be a client device.

According to yet another exemplary embodiment, there is provided a data sharing method of a first device for sharing data with a second device. The method may comprise: emulating a virtual universal serial bus (USB) device including a storage device; transmitting a USB control message used in accessing the storage device of the virtual USB device, to the second device; and sharing data with the second device, when the second device authenticates via the USB control message.

According to yet another exemplary embodiment, there is provided a data sharing method of a data sharing system including a first device and a second device, the data sharing method comprising: emulating by the first device a virtual universal serial bus (USB) device including a storage device; transmitting by the first device a USB control message used for accessing the storage device of the virtual USB device, to the second device; processing by the second device the transmitted USB control messages; and obtaining by the second device authority to access the large capacity of the virtual USB device using the processed USB control message.

### BRIEF DESCRIPTION OF THE DRAWINGS

The above and/or other aspects of the present disclosure will be more apparent by describing certain present disclosure with reference to the accompanying drawings, in which:

FIG. 1 is a block diagram of a system environment, in accordance with one exemplary embodiment of the present disclosure;

FIG. 2 is a block diagram of a server device which enables data sharing between a server device and client device, in accordance with one exemplary embodiment of the present disclosure;

FIG. 3 is a flowchart explaining a method enabling data sharing between a server device and client device, in accordance with one exemplary embodiment of the present disclosure;

FIG. 4 is a block diagram illustrating a configuration of a client device which shares data with a server device; and

FIG. 5 is a flowchart explaining a method where a client device shares data with a server device.

### DETAILED DESCRIPTION

Certain exemplary embodiments are described in higher detail below with reference to the accompanying drawings.

It should be observed that the method operations and system components have been represented by conventional symbols in the figure, showing only specific details which are relevant for an understanding of the present disclosure. Further, details which may be readily apparent to a person ordinarily skilled in the art may not have been disclosed. In the present disclosure, relational terms such as first and second, and the like, may be used to distinguish one entity from another entity, without necessarily implying any actual relationship or order between such entities.

Exemplary embodiments of the present disclosure described herein provide a system and method of sharing data between a server device and a client device.

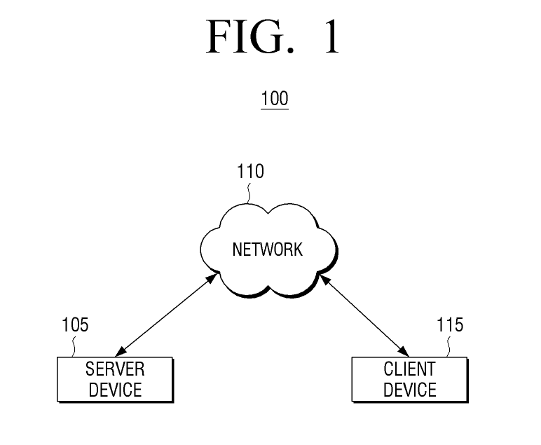

FIG. 1 is a block diagram of an environment 100 in accordance with which various exemplary embodiments can be implemented. The environment 100 includes a server device 105, a client device 115 and a network 110. The server device 105 and the client device 115 are connected to each other through the network 110. The client device 115 includes a multimedia device. Examples of the multimedia device include, but are not limited to, a digital television, a mobile device, a personal digital assistant (PDA), a smart phone and other hand held devices. Examples of the network 110 include a local area network, a wide area network and a wireless network.

In one example, the server device 105 can include the multimedia device, for example, the smart phone. The smart phone is configured to store various multimedia contents, for example, but not limited to, video files, such as, movies, video files and audio files. Further, the client device 115 can include, the multimedia device, for example, the digital television.

The multimedia contents stored in the smart phone is played on the digital television by connecting the smart phone as a virtual universal serial bus (USB) device to the digital television.

The smart phone is configured to emulate the virtual USB device. The virtual USB device emulated includes contents present in a storage device associated with the smart phone. Emulation also includes creation of a mass storage device by the smart phone. The mass storage device is used for storing the multimedia contents. Further, the smart phone transmits various USB control messages that enables the digital television to access the mass storage device. The USB control messages are transmitted, to the digital television, in the form of various universal serial bus request block (URB) units. The URB units can be transmitted via wireless networks, for example, Bluetooth and the like. The URB units enable emulation of the virtual USB device such that the virtual USB device emulated can be shared with the digital television.

Further, the digital television receives the URB units. The URB units are processed by the digital television. One or more drivers embedded in the digital television are used for processing the URB units. The processing of the URB units enables the digital television to access the mass storage device. Furthermore, upon accessing the mass storage device, a multimedia player embedded in the digital television is configured to play the multimedia contents stored in the mass storage device.

Hence, a first multimedia device can share multimedia content or data with a second multimedia device by emulating the virtual USB by the first multimedia device. The virtual USB device that is emulated includes the data and the multimedia contents present in the storage device of the first multimedia device. Further, the emulated USB device will be exported to the second multimedia device such that the second multimedia device can connect the emulated USB device as the virtual USB device and further, the second multimedia device is enabled to access the data and multimedia contents included in the virtual USB device.

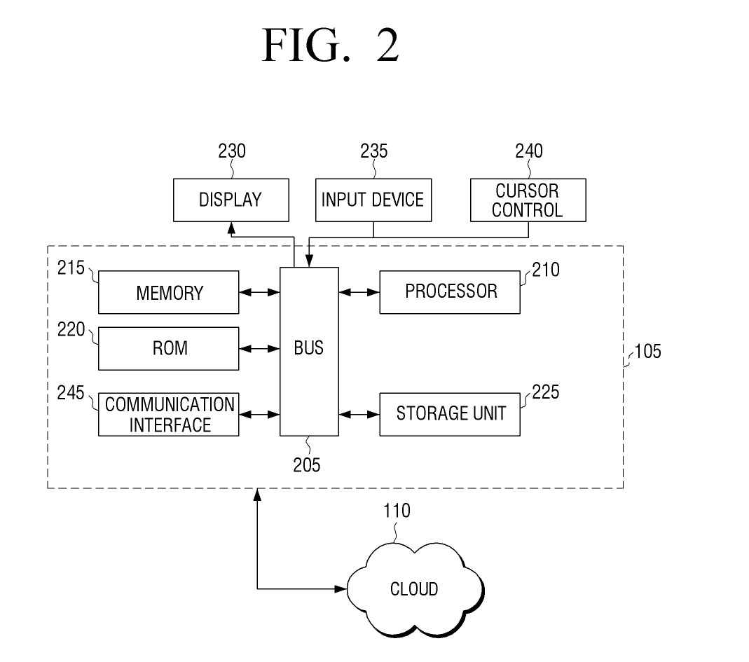

A server device including a plurality of elements that is configured to emulate the virtual USB device is explained in detail in conjunction with FIG. 2.

The server device 105 includes a bus 205 or other communication mechanism for communicating information, and a processor 210 coupled with the bus 205 for processing information. The server device 105 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The server device 105 further includes a read only memory (ROM) 220 or other static storage device coupled to the bus 205 for storing static information and instructions for the processor 210. A storage unit 225, for example a magnetic disk or optical disk, is provided and coupled to the bus 205 for storing information.

The server device 105 can be coupled via the bus 205 to a display 230, for example a cathode ray tube (CRT), for displaying multimedia content. The input device 235, including alphanumeric and other keys, is coupled to the bus 205 for communicating information and command selections to the processor 210. Another type of user input device is the cursor control 240, for example a mouse, a trackball, or cursor direction keys for communicating direction information and command selections to the processor 210 and for controlling cursor movement on the display 230.

Various exemplary embodiments are related to the use of the server device 105 for implementing the techniques described herein. In some exemplary embodiments, the techniques are performed by the server device 105 in response to the processor 210 executing instructions included in the memory 215. Such instructions can be read into the memory 215 from another machine-readable medium, for example the storage unit 225. Execution of the instructions included in the memory 215 causes the processor 210 to perform the process operations described herein.

In some exemplary embodiments, the processor 210 can include one or more processing units for performing one or more functions of the processor 210. The processing units are hardware circuitry used in place of or in combination with software instructions to perform specified functions.

The term “machine-readable medium” as used herein refers to any medium that participates in providing data that causes a machine to perform a specific function. In an exemplary embodiment implemented using the server device 105, various machine-readable media are involved, for example, in providing instructions to the processor 210 for execution. The machine-readable medium can be a storage medium, either volatile or non-volatile. A volatile medium includes, for example, dynamic memory, such as the memory 215. A non-volatile medium includes, for example, optical or magnetic disks, for example the storage unit 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punch cards, paper tape, any other physical media with patterns of holes, a random-access memory (RAM), a programmable read-only memory (PROM), and an erasable programmable read-only memory (EPROM), a FLASH-EPROM, any other memory chip or cartridge.

In another exemplary embodiment, the machine-readable media can be transmission media including coaxial cables, copper wire and fiber optics, including the wires that include the bus 205. Transmission media can also take the form of acoustic or light waves, such as those generated during radio-wave and infra-red data communications. Examples of machine-readable media may include, but are not limited to, a carrier wave as described hereinafter or any other media from which the server device 105 can read. For example, the instructions can initially be carried on a magnetic disk of a remote computer. The remote computer can load the instructions into its dynamic memory and send the instructions over a telephone line using a modem. A modem local to the server device 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the storage unit 225 either before or after execution by the processor 210. All such media must be tangible to enable the instructions carried by the media to be detected by a physical mechanism that reads the instructions into a machine.

The server device 105 also includes a communication interface 245 coupled to the bus 205. The communication interface 245 provides a two-way data communication coupling between the client device and the server device 105 through the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. In any such implementation, the communication interface 245 sends and receives electrical, electromagnetic or optical signals that carry digital data streams representing various types of information.

The processor 210 in the server device 105 is operable to receive a request from the client device. The request being used to establish a connection between the client device and the server device 105. The request can be transmitted by the client device via one or more wireless networks. The processor 210 is further operable to determine an authenticity of the client device to access the server device. An authentication module included in the processor 210 is used to determine the authenticity. The authenticity of the client device is determined to prevent unauthorized users from accessing the server device 105. Further, the processor 210 is operable to emulate a USB device to generate an emulated USB device. The emulated USB device includes a mass storage device for storing data, for example, multimedia content. A USB mass storage emulator included in the processor 210 is used for emulating the emulated USB device. Further, a virtual small computer system interface (SCSI) controller module included in the processor 210 can be used for emulation of the emulated USB device on a file system existing on the server device 105. Furthermore, the processor 210 is operable to transmit a plurality of USB control messages to the client device. The USB control messages are being used to access the mass storage device. In some exemplary embodiments, the processor 210 encrypts the USB control messages prior to transmitting the USB control messages to the client device. An encryption module included in the processor 210 is used for encrypting the USB control messages. The processor 210 encrypts the USB control messages to secure data during transmission.

In one exemplary embodiment, the processor 210 is included on a client device, for example, the client device 115. The processor 210 when included on the client device is configured to receive the plurality of USB control messages. Further, the processor 210 is operable to process the plurality of USB control messages. The processor 210 processes the plurality of USB control messages for accessing the mass storage device. The processor 210 employs multiple drivers, for example, but not limited to, a USB mass storage driver, a virtual host controller (VHCD) driver and the like for processing the USB control messages. The processor 210 upon processing connects the emulated USB device as a virtual USB device to the client device. In some exemplary embodiments, the processor 210 included in the client device is configured to play the multimedia contents stored in the mass storage device. The processor 210 employs a multimedia player embedded in the client device for playing the multimedia contents.

Hence the server device 105 exports the emulated USB device to the client device such that the client device connects the emulated USB device exported as the virtual USB device for accessing data included in the virtual USB device. Further, the server device 105 enables sharing of the emulated USB device with the client device without physical connection of the virtual USB device to the client device. Hence there is no USB device connected physically either at server device or client device.

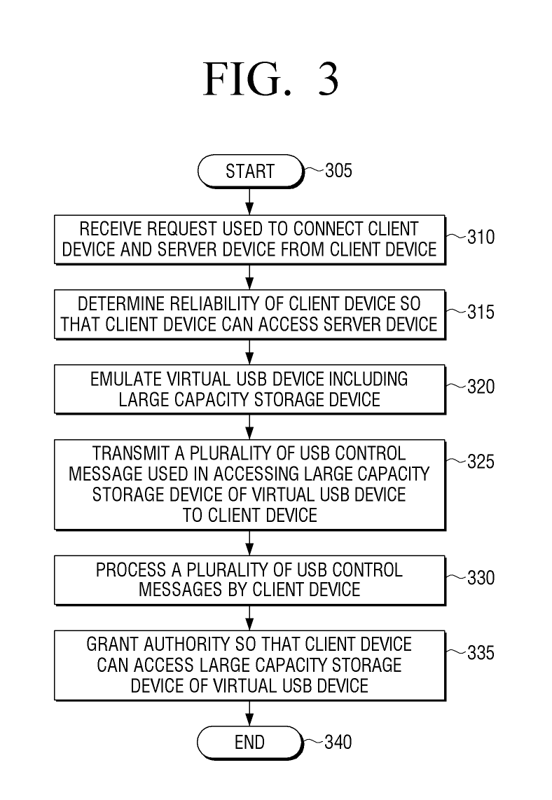

A method of enabling sharing of data between a server device and a client device is explained in detail in conjunction with FIG. 3.

FIG. 3 is a flowchart illustrating a method of enabling sharing of data between a server device and a client device, in accordance with one exemplary embodiment. The method starts at operation 305.

At operation 310, a request is received from the client device. The request includes a need for establishing a connection between the client device and the server device. The client device transmits the request via a wireless network. Examples of the wireless network include, but are not limited to, Bluetooth and the like. The request is transmitted to the server device via one or more communication protocols, for example, a TCP/IP connection protocol.

At operation 315, an authenticity of the client device to access the server device is determined. In one example, the server device can store a list of client devices that are authorized to access the server device. The list of client devices can be stored in a database associated with the server device.

When the server device receives the request from the client device, the server device can analyze the list of client devices to identify if the client device that has transmitted the request is included in the list of client devices that are authorized to access the client device. If the client device that has transmitted the request is included in the list of client devices, then the client device can access the server device.

At operation 320, a virtual universal serial bus (USB) device is emulated to generate an emulated USB device. The emulated USB device is connected, to the client device, as a virtual USB device. Hence, the virtual USB device can be shared with the client device without physically connecting a USB device to the client device. The virtual USB device also includes a mass storage device for storing data. In one example, the data can include multimedia content such as video content and audio content. In another example, the data can also include images.

In some exemplary embodiments, initialization of the virtual USB device can be performed by receiving various USB control messages from the client device. The USB control messages include one or more software requirements that enable the client device to access the mass storage device of the virtual USB device. The USB control messages are transmitted, by the client device, in the form of universal serial bus request block (URB) units.

Further, one or more SCSI commands are extracted from the USB control messages. The SCSI commands are used to read internal storage of the emulated USB device. In one example, a virtual file system included in the server device is used to read internal storage of the emulated USB device. Reading the internal storage of the emulated USB device enables the client device to connect the emulated USB device as the virtual USB device. Further, the client device can access the virtual USB device.

At operation 325, the USB control messages received from the client device are transmitted back to the client device by the server device. The USB control messages that are transmitted back to the client device enable the client device to access the virtual USB device. The USB control messages are transmitted, by the server device, in the form of the URB units.

In one exemplary embodiment, the USB control messages are encrypted prior to transmission of the USB control messages to the client device. Encryption of the USB control messages enables protection of the data from unauthorized access.

At operation 330, the USB control messages are processed by the client device. In one example a VHCD driver, of the client device, may be used for processing the USB control messages. Further, the processing includes transmission of the USB control messages to a USB core driver, of the client device, for enabling the USB core driver to access the mass storage device of the virtual USB device.

In one exemplary embodiment, the USB control messages are decrypted prior to processing the USB control messages.

At operation 335, the client device is enabled to gain access to the mass storage device of the virtual USB device. In one example, a USB mass storage device driver embedded within the client device is used to gain access to the mass storage device. Further, upon accessing the mass storage device, the client device can employ the virtual USB device for performing various tasks.

In some exemplary embodiments, upon accessing the mass storage device, a multimedia player associated with the client device can view the mass storage device. Further, the multimedia player can select an audio file or a video file for playing the multimedia content on the client device. Furthermore, in some exemplary embodiments, the client device is enabled to perform different tasks, for example, copying, deleting, formatting and modifying the content included in the mass storage device. Moreover, in some exemplary embodiments, a client can open various files, for example, but not limited to, office files, document files, and image files on the client device and can even modify them and store it on the virtual USB device.

In some exemplary embodiments, the method enables virtualization of interrupt based devices and isochronous USB devices. The interrupt based devices are used to control game server agents from a main server. The method enables emulation of a keyboard and mouse associated with the game server agents that can be exported to the main servers as a virtual USB keyboard. Further, the virtual USB keyboard can be controlled from the main server. Furthermore, the isochronous USB devices, for example, a USB webcam can be emulated using camera of a smart phone to stream video to a digital television screen.

The method stops at operation 340.

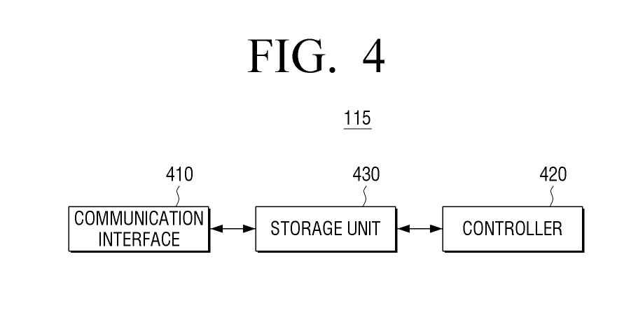

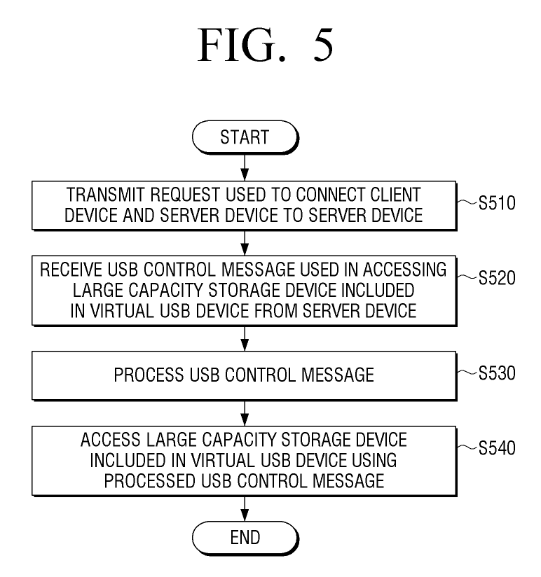

Hereinbelow is detailed explanation on a method of sharing data of a client device, with reference to FIGS. 4 and 5.

FIG. 4 is a block diagram illustrating a configuration of a client device 115 in accordance with an exemplary embodiment of the present disclosure. As illustrated in FIG. 4, the client device 115 includes a communication interface 410, storage unit 430, and controller 420. Herein, the client device 115 may be embodied as a multimedia device such as a digital television, mobile device, PDA, smart phone and miniature device etc.

Meanwhile, the client device 115 illustrated in FIG. 4 only illustrates a configuration necessary for explaining a data sharing function, and thus additional configurations such as a displayer and user inputter may be added or changed, in a case where various functions such as a display function and an internet search function etc. are provided.

The communication interface 410 provides a two way data communication connected between the client device 115 and server device 105. For example, the communication interface 410 may be an ISDN card or modem format which may provide data communication of a type corresponding to a telephone line. For another example, the communication interface 410 may have a LAN card format so as to provide data communication to compatible LAN. In this case, the communication interface 410 transmits and receives electrical, electromagnetic, and optical signals which may move a digital data stream representing various types of information.

The storage unit 430 stores various programs and data for controlling the client device 115. In particular, the storage unit 430 may store multimedia contents received from the large capacity storage medium included in the virtual USB device emulated by the server device 105.

The controller 420 controls the overall operations of the client device 115. In particular, the controller 420 may control the communication interface 410 to transmit a request used in connecting between the client device 115 and server device 105 to the server device 105.

In addition, when it is determined by the server device 105 that there is reliability of the client device 115, and the virtual USB device including a large capacity storage device is emulated by the server device 105, the controller 420 may control the communication interface 410 to receive the USB control message used in accessing the large capacity storage device of the USB device from the server device 105. Herein, the USB control message may include at least one software condition that enables accessing the large capacity storage device of the virtual USB device by the client device 115.

In addition, the controller 420 processes the transmitted USB control messages. For example, when the transmitted USB control message is encrypted, controller 420 may decrypt the encrypted USB control message.

In addition, the controller 420 may use the processed USB control message to obtain an authority to access the large capacity storage device of the virtual USB device so as to share data with the server device 105.

FIG. 5 is a flowchart for explaining a method of sharing data of the client device 115 in accordance with one exemplary embodiment of the present disclosure.

First, the client device 115 transmits a request used to connect the client device 115 and the server device 105 to the server device 105 (S510).

In addition, the client device 115 receives a USB control message used in accessing the large capacity storage device included in the virtual USB device from the server device 105 (S520). More specifically, when the server device 105 determines that there is reliability of the client device 115 and emulates the virtual USB device including the large capacity storage device, the client device 115 may receive the USB control message used in accessing the large capacity storage device included in the virtual USB device from the server device 105.

In addition, the client device 115 processes the received USB control message (S530). For example, the client device 115 may decrypt the encrypted USB control message.

In addition, the client device 115 uses the processed USB control message to access the large capacity storage device included in the virtual USB device (S540). Accordingly, the client device 115 becomes able to use the multimedia contents stored in the large capacity device of the virtual USB device.

Advantageously, the exemplary embodiments specified in the present disclosure enables emulation of a virtual USB device so that multimedia devices can play multimedia content included in the virtual USB device without physically connecting a USB device. By emulating the virtual USB device, the virtual USB device can be exported to multiple clients from a single server. Further, the method enables authentication of multiple clients prior to accessing the virtual USB device to prevent unauthorized access. The method also provides enhanced security by managing privilege levels and access levels of the clients. Further, the method enables encryption of data prior to transmission of the data to the clients. Moreover, the method enables sharing of data between both public network and private network. Further, by emulating the virtual USB device, the necessity to connect USB cables for data transfer is eliminated. Also, emulation of the virtual USB device eliminates the need for installing one or more devices, OS specific applications or one or more drivers to support sharing of the data. Furthermore, by emulating the virtual USB devices, the electronic devices that do not include an USB port can also share data.

Although a few exemplary embodiments have been shown and described, it would be appreciated by those skilled in the art that changes may be made in these exemplary embodiments without departing from the principles and spirit of the invention, the scope of which is defined in the claims and their equivalents.

What is claimed is:

1. A data sharing method of a first device for sharing data with a second device, the method comprising:
receiving a request related to communicating with the second device, from the second device;
determining a reliability of the second device;
emulating a virtual universal serial bus (USB) device including a storage device, when it is determined that there is reliability in the second device;
transmitting a USB control message used in accessing the storage device of the virtual USB device, to the second device; and
sharing data with the second device, when the second device authenticates via the USB control message.

2. The method according to claim 1,
wherein the determining comprises storing a list including information on second devices for which data sharing is approved;
determining whether or not the second device is included in the list; and
determining that there is reliability in the second device, when the second device is included in the list.

3. The method according to claim 1,
further comprising encrypting the USB control message,
wherein the encrypted USB control message is decrypted by the second device.

4. The method according to claim
wherein the USB control message is transmitted in a format of a plurality of URB (Universal serial bus request block) units.

5. The method according to claim 1,
wherein the USB control message is processed by a plurality of drivers mounted on the second device, and
the second device uses the processed USB control message to determine whether or not the second device has authority to access the storage device of the virtual USB device.

6. A server device for sharing data with a client device, the server device comprising:
a communication interface configured to perform communication with the client device; and
a controller configured to control the communication interface to receive a request related to communicating with the client device, from the client device,
determine reliability of the client device, and when it is determined that there is reliability in the client device, emulates a virtual universal serial bus (USB) device including a storage device,
control the communication interface to transmit a USB control message used in accessing the storage device of the virtual USB device, to the client device, and
share data with the client device, when the client device authenticates via the USB control message.

7. The server device according to claim 6, further comprising a storage unit,
wherein the storage unit stores a list including information on client devices for which data sharing is approved, and
the controller determines whether or not the client device is included in the list, and when the client device is included in the list, determines that there is reliability in the client device.

8. The server device according to claim 6,
wherein the controller encrypts the USB control message, and
the encrypted USB control message is decrypted by the client device.

9. The server device according to claim 6,
wherein the controller controls the communication interface to transmit USB control messages in a format of a plurality of URB (Universal serial bus request block) units.

10. The server device according to claim 6,
wherein the USB control message is processed by a plurality of drivers mounted on the client device, and
the client device uses the processed USB control message to determine whether or not the client device has authority to access the storage device of the virtual USB device.

11. A data sharing method of a data sharing system including a first device and a second device, the data sharing method comprising:
transmitting by the second device a request used to connect the second device and the first device, to the first device;
determining, by first device, reliability of the second device, so that the second device can access the first device;
emulating by the first device a virtual universal serial bus (USB) device including a storage device, when it is determined that there is reliability in the second device;
transmitting by the first device a USB control message used for accessing the storage device of the virtual USB device, to the second device;
processing by the second device the transmitted USB control messages; and
obtaining by the second device authority to access the large capacity of the virtual USB device using the processed USB control message.

12. A data sharing method of a second device, the method comprising:
transmitting a request used to connect the second device and a first device, to the first device;
receiving a universal serial bus (USB) control message used for accessing a storage device of a virtual USB device from the first device;
processing transmitted USB control messages; and
accessing the storage device of the virtual USB device using at least one from among the processed USB control messages.

13. The method according to claim 12,
wherein the virtual USB device is emulated by the first device when it is determined that there is reliability in the second device.

14. The method according to claim 12, wherein the USB control message received from the first device is encrypted, and the method further comprising decrypting the encrypted USB control message.

15. The method according to claim 12,
wherein the USB control message comprises at least one software condition enabling the second device to access the storage device of the virtual USB device.

16. A client device for sharing data with a server device, the client device comprising:
a communication interface configured to communicate with the server device; and
a controller configured to transmit a request related to connecting the client device and server device to the server device, control the communication interface to receive a universal serial bus (USB) control message used to access a storage device of a virtual USB device from the server device, and process the transmitted USB control messages to access the storage device of the virtual USB device.

17. The client device according to claim 16,
wherein the virtual USB device is emulated by the server device, when it is determined that there is reliability in the client device.

18. The client device according to claim 16,
wherein the USB control message received from the server device is encrypted, and
the controller decrypts the encrypted USB control message.

19. The client device according to claim 16,
wherein the USB control message includes at least one software condition which enables the client device to access the storage device of the virtual USB device.

20. The method according to claim 1, wherein the first device is a server device and the second device is a client device.

21. The method according to claim 11, wherein the first device is a server device and the second device is a client device.

22. The method according to claim 12, wherein the first device is a server device and the second device is a client device.

23. A data sharing method of a first device for sharing data with a second device, the method comprising:
emulating a virtual universal serial bus (USB) device including a storage device;
transmitting a USB control message used in accessing the storage device of the virtual USB device, to the second device; and
sharing data with the second device, when the second device authenticates via the USB control message.

24. A data sharing method of a data sharing system including a first device and a second device, the data sharing method comprising:
emulating by the first device a virtual universal serial bus (USB) device including a storage device;
transmitting by the first device a USB control message used for accessing the storage device of the virtual USB device, to the second device;
processing by the second device the transmitted USB control messages; and
obtaining by the second device authority to access the large capacity of the virtual USB device using the processed USB control message.
